(19) United States
(12) Patent Application Publication
(10) Pub. No.: US 2011/0105196 A1
(43) Pub. Date: May 5, 2011

(54) SYSTEM AND METHOD FOR MECHANICALLY REDUCING UNWANTED WIND NOISE IN A TELECOMMUNICATIONS HEADSET DEVICE

(75) Inventors: Taisen Maddern, Melbourne (AU); Adrian Tan, Melbourne (AU)

(73) Assignee: BLUEANT WIRELESS PTY LIMITED, Richmond (AU)

(21) Appl. No.: 12/829,223

(22) Filed: Jul. 1, 2010

Related U.S. Application Data
(60) Provisional application No. 61/257,371, filed on Nov. 2, 2009.

(51) Int. Cl. H04M 1/00; H04R 19/04

(52) U.S. Cl. 455/569.1; 381/359

(57) ABSTRACT

A system and method for mechanically reducing unwanted wind, audio, and other noise in a telecommunications headset or other device. In accordance with an embodiment, a headset housing includes one or more openings or ports for use with one or more, microphones. A portion of the housing which contains the ports is overlaid with a combination of one or more metal or plastic grills, and a sound-reducing felt or other material. Used separately or with other features, this provides for mechanical and/or pattern-based noise reduction, particularly of wind noise. In accordance with some embodiments the voice microphone can be held in place within a microphone mounting boot which allows sound to impinge the microphone in a configured pattern.

### CLAIM OF PRIORITY

This application claims the benefit of priority to U.S. Provisional Patent Application No. 61/257,371 titled “SYSTEM AND METHOD FOR MECHANICALLY REDUCING UNWANTED WIND NOISE IN A TELECOMMUNICATIONS HEADSET DEVICE”, filed Nov. 2, 2009, of which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The invention is generally related to telecommunications, audio headsets, speakers, and other communications devices, such as mobile telephones and personal digital assistants, and is particularly related to a system and method for mechanically reducing noise in a telecommunications headset device.

### BACKGROUND

The use of telecommunications devices, particularly mobile telephones, computers, and personal digital assistants, continues to become widespread, and both business and casual users alike commonly have one or more, and in some instances several such devices. Such devices are no longer confined to people's homes and businesses, but are commonly used in other environments, such as while driving, in the park, or at sporting and other entertainment events. However, one of the commonly encountered problems, say while using a telephone outdoors, is that the person at the other end may have difficulty hearing the caller. Background noise, and particularly wind noise, can greatly diminish the ability of a person's voice to be heard. This is particularly pertinent in headset devices, since such devices are generally small enough to be mounted on a person's ear, which necessarily places the microphone quite far from the person's mouth, and in such a position that it is exposed to wind and other noise. Various techniques of disrupting wind interference, and/or compensating for ambient noise, have been proposed, with varying levels of success. This is the general area that embodiments of the present invention are intended to address.

### SUMMARY

Described herein is a system and method for mechanically reducing unwanted wind, audio, and other noise in a telecommunications headset or other device. In accordance with an embodiment, a headset housing includes one or more openings or ports for use with one or more, microphones. A portion of the housing which contains the ports is overlaid with a combination of one or more metal or plastic grills, and a sound-reducing felt or other material. Used separately or with other features, this provides for mechanical and/or pattern-based noise reduction, particularly of wind noise. In accordance with some embodiments the voice microphone can be held in place within a microphone mounting boot which allows sound to impinge the microphone in a configured pattern.

### BRIEF DESCRIPTION OF THE DRAWINGS

FIG. 1 shows an illustration of an example device that can utilize both mechanical and/or microphone pattern-based noise reduction, in accordance with an embodiment.

FIG. 2 shows an illustration of a headset as it may be used by a person, in accordance with an embodiment.

FIG. 3 shows an illustration of a headset that includes noise reduction, in accordance with an embodiment.

FIG. 4 shows an illustration of a microphone mounting boot, in accordance with an embodiment.

FIG. 5 shows an illustration of an alternate microphone mounting boot, in accordance with an embodiment.

FIG. 6 shows an illustration of a headset as it may be used by a person, and including a headset microphone pattern, in accordance with an embodiment.

FIG. 7 shows an illustration of a headset that includes both mechanical and pattern-based noise reduction, in accordance with an embodiment.

### DETAILED DESCRIPTION

Described herein is a system and method for mechanically reducing unwanted wind, audio, and other noise in a telecommunications headset or other device. In accordance with an embodiment, a headset housing includes one or more openings or ports for use with one or more, microphones. A portion of the housing which contains the ports is overlaid with a combination of one or more metal or plastic grills, and a sound-reducing felt or other material. Used separately or with other features, this provides for mechanical and/or pattern-based noise reduction, particularly of wind noise. In accordance with some embodiments the voice microphone can be held in place within a microphone mounting boot which allows sound to impinge the microphone in a configured pattern. In accordance with an embodiment, the system includes one or more of:
Use of an arrangement or combination of two or more uni-directional and/or omni-directional microphones, that are configured to best reduce or eliminate unwanted noise.
Use of a turbulence-breaking metal or plastic grill to reduce the effect of wind hitting the microphones.
Use of a wind-resistant felt or other material to reduce the velocity of wind hitting the microphones.
Use of a microphone sound-receiving pattern, such as a cardioid, hypercardioid, supercardioid, or other custom pattern, that enables a distinction between desired voice input, and non-desired noise input, and which can be provided using a pattern-generating microphone boot.

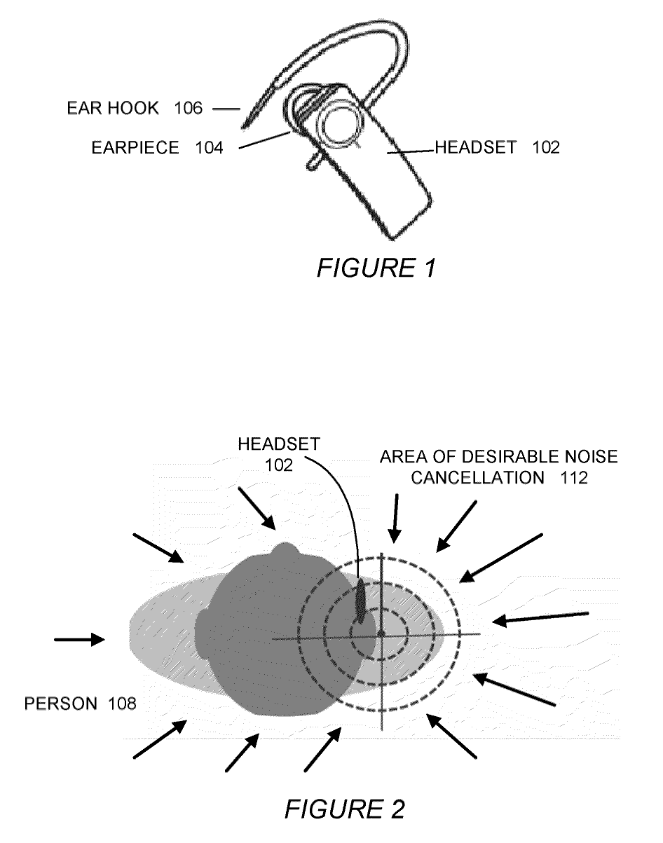

FIG. 1 shows an illustration of an example device that can utilize both mechanical and/or microphone pattern-based noise reduction, in accordance with an embodiment. For purposes of illustration, the device shown in FIG. 1 and generally described throughout this description is a telecommunications headset device, such as a Bluetooth-enabled headset that might be used with a mobile telephone. In accordance with various embodiments some or all of the features disclosed herein can be similarly used or implemented within other communications devices, such as mobile telephones, personal digital assistants, speakerphones, and in-car speakers. As shown in FIG. 1, the headset 102 typically includes an earpiece and/or speaker assembly 104 that can be placed near or in the user's ear, and which allows the user to listen to the headset. The headset typically also includes an ear hook 106 or other means for securing the headset to the user's ear. Other communications devices can include similar features.

FIG. 2 shows an illustration of a headset 102 as it may be used by a person 108, in accordance with an embodiment. During operation, it is desirable that the headset maximizes the vocal input spoken by the user, while at the same time minimizing extraneous noise effects, such as wind, background traffic, or other unwanted noise. FIG. 2 shows an ear-mounted headset supported on the right-side ear of the person. In such a position, the person's head, torso, and pinna (the outer portion) of their ear provides reasonably good protection from unwanted noise originating at the user's left side. However, the headset is still very susceptible to unwanted noise originating at the person's right side. Since the headset must pick up spoken words from the front of the person, in the example shown in FIG. 1 an important area of desirable noise cancellation 112 is to the front-right of the person. It will be evident that, if the headset device is instead worn on the opposite ear, then the area of desirable noise cancellation would be reversed. Different communications devices may have different areas of desirable noise cancellation, depending on their structure and their positioning with respect to the person.

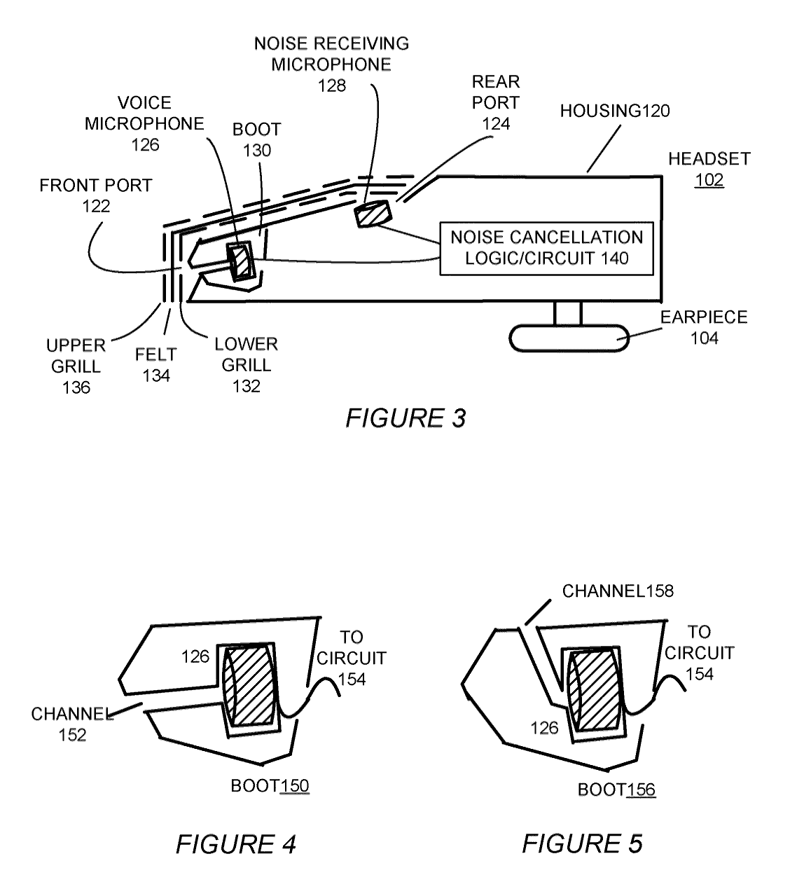

FIG. 3 shows an illustration of a headset that includes noise reduction, in accordance with an embodiment. As shown in FIG. 3, the headset 102 includes an earpiece 104 that includes a speaker assembly, and a housing 120, which may be formed in several parts that fit together. In accordance with an embodiment, the housing includes at least two openings, illustrated here as a front port 122 relatively closer to the mouth of the person, and a rear port 124 located a few millimeters further back, each of which ports allow sound input to enter the device. Two microphones are provided within the housing, including a voice microphone 126 generally located in the area of the first port, and a noise receiving microphone 128 generally located in the area of the rear port. Since each microphone is capable of receiving both vocal input and unwanted noise input, the above are mostly labels for purposes of illustration. In particular, the voice microphone can use inputs received both from the front port and the rear port, which can then be subtracted or otherwise processed to provide a measure of the input noise. In accordance with various embodiments, additional ports and/or microphones can be provided; and the voice microphone and noise microphones can be a combination of uni-directional and/or omni-directional.

In accordance with an embodiment, the voice microphone is held in place within a microphone mounting boot 130, which allows sound to impinge the microphone in a configured pattern, and which is described in further detail below.

In accordance with an embodiment, the portion of the housing which contains the front and rear port, together with the ports themselves, is overlaid with a combination of a metal or plastic grill and a sound-reducing felt or other material, which together provides mechanical noise reduction. In accordance with an embodiment, a lower grill 132, a felt layer 134, and an upper grill 136 is layered over the ports. The grills act to reduce the turbulent effect of wind hitting the microphone, while the felt acts to reduce the velocity of wind hitting the microphone.

In accordance with an embodiment, the microphones are each connected to a noise cancellation logic/circuit 140, which uses the input from the microphones to best reduce the unwanted noise.

FIG. 4 shows an illustration of a microphone mounting boot 150, in accordance with an embodiment. As described above, in accordance with an embodiment, the voice microphone is held in place within the housing the microphone mounting boot, which can be made of a rubber, plastic or other vibration- and sound-dampening material, and both retains and substantially surrounds the voice microphone. A hollow channel 152 is provided within the boot, which allows sound to impinge the microphone in a configured pattern. In particular, the channel 152 can be angled in a particular direction, or have a particular length or width, to effect the sound receiving pattern. The boot further includes an electrical wire or other connection 154 to the noise cancellation logic/circuit. FIG. 5 shows an illustration of an alternate microphone mounting boot 156, which illustrates the channel 158 angled in a different direction, and which results in a different microphone sound receiving pattern.

In accordance with an embodiment, the boot, including the channel angle and dimensions, can be configured to create a customized sound receiving pattern, such as a cardioid, hypercardioid, supercardioid, or other custom sound receiving pattern at the headset. Pattern stability is important for consistent response in the headset. In some instances a pure cardioid pattern is less stable, and provides less stability when used in a headset. Instead, a pure bidirectional pattern, hypercardioid pattern, or supercardioid pattern can be used for greater stability. When used in a particular implementation such as a particular headset device construction, the sound receiving pattern can be customized by changing the parameters of the boot (such as the channel angle, dimensions, or other parameters) to best suit the particular requirements of that construction. Different implementations and constructions, with different requirements, may benefit from a different sound receiving pattern, which in turn can be provided by selecting different boot parameters.

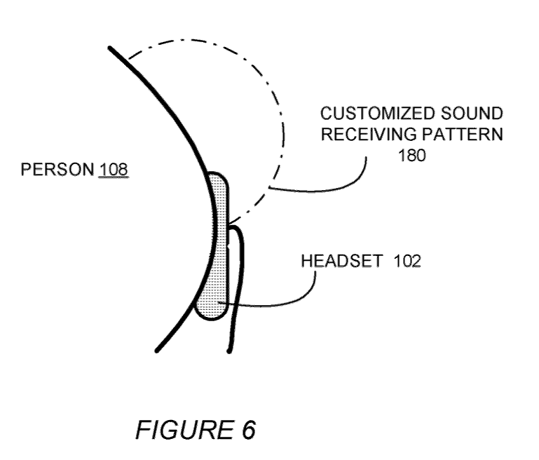

FIG. 6 shows an illustration of a headset 102 as it may be used by a person 108, and including a headset microphone pattern, in accordance with an embodiment. FIG. 6 again shows an ear-mounted headset supported on the right-side ear of the person. As described above, in such an example, an important area of desirable noise cancellation 112 is to the front-right of the person. In accordance with an embodiment, the boot is configured to create a customized sound receiving pattern 180, such as a hypercardioid sound receiving pattern or other pattern that particularly targets the vocal input, and separates the noise in the area of desirable noise cancellation.

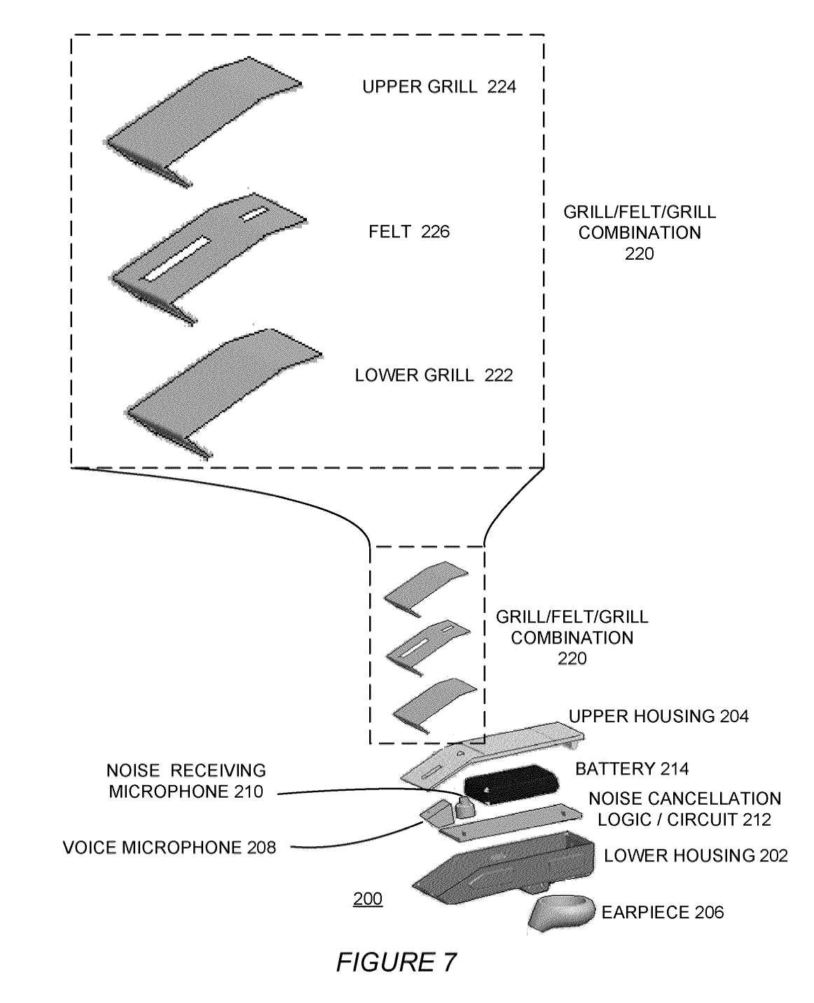

FIG. 7 shows an illustration of a headset that includes both mechanical and pattern-based noise reduction, in accordance with an embodiment. As shown in FIG. 7, a grill/felt/grill combination, including one or more metal or plastic grills and a sound-reducing felt material can be used to mechanically reduce unwanted noise. In accordance with an embodiment, the headset 200 includes a lower housing 202 and an upper housing, which fit together, and an earpiece 206 that includes a speaker assembly. The housing includes at least two openings or ports (not illustrated) in the upper housing. Two microphones are provided within the housing, including a voice microphone 208 generally located in the area of the first port, and a noise receiving microphone 210 generally located in the area of the rear port. In accordance with an embodiment, the voice microphone is held in place within a microphone mounting boot, described previously. The microphones are each connected to a noise cancellation logic/circuit 212, which can be provided as a printed circuit board (PCB), and which in turn is powered by an internal battery 214. The portion of the housing which contains the front and rear port is overlaid with a grill/felt/grill combination 220, including one or more metal or plastic grills 222, 224 and a sound-reducing felt material 226, which together provides mechanical noise reduction. In accordance with an embodiment, the lower grill 222 is approximately 5 mm in thickness; and the upper grill 224 is approximately 3 mm in thickness. Different implementations and constructions, with different requirements, may benefit from different arrangements, materials, and thicknesses of the grills and/or the sound-reducing materials.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. For example, as described above, the sound receiving pattern can be customized by changing the parameters of the boot to best suit the requirements of a particular implementation. Different implementations, with different requirements, may benefit from a different sound receiving pattern, which in turn can be provided by selecting different boot parameters. It is intended that the scope of the invention be defined by the following claims and their equivalence.

Some aspects of the present invention may be conveniently implemented using one or more conventional general purpose or specialized digital computer, computing device, machine, microprocessor, or electronic circuits, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium or computer readable medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

What is claimed is:

1. A system for reducing noise in a telecommunications device, comprising:
one or more microphones, each of which is retained in a microphone boot that allows sound to impinge the microphone in a configured pattern, and wherein the pattern is configured to optimize reception of desired vocal input and reduce the reception of non-desired noise input;
a metal or plastic grill placed over the microphone to reduce the effect of wind hitting the microphone; and
a wind-resistant felt or other material placed between the microphone and the grill to reduce the velocity of wind hitting the microphones.

2. The system of claim 1, wherein the microphone boot is made of rubber, plastic, or another vibration- or sound-reducing material, and includes a hollow channel through which sound can impinge upon the microphone.

3. The system of claim 2, wherein the microphone boot and hollow channel is configured to allow sound to impinge the telecommunications device in a customized sound receiving pattern that suits the particular requirements of an implementation of the telecommunications device.

4. The system of claim 2, wherein the microphone boot and hollow channel is configured to allow sound to impinge the telecommunications device in a hypercardioid pattern, and includes distinct pattern areas for vocal input and for noise input.

5. The system of claim 1, wherein the system includes two metal or plastic grills placed over the microphone, including a first grill placed nearest the microphone, covered with the wind-resistant felt or other material, and then a second grill covering the wind-resistant felt.

6. The system of claim 1, wherein the system is provided in a telecommunications, Bluetooth, or other headset.

7. The system of claim 1, wherein the system is provided in a speakerphone, or in-car speaker.

8. A telecommunications headset which provides wind noise reduction, comprising:
an earpiece;
a housing that includes at least two openings or ports, each of which ports are covered by a combination of a grill or felt to reduce wind noise, including when the housing is placed in the ear of a user, a first port located closer to the mouth of the user, and a second port located further from the mouth of the user;
a plurality of microphones provided within the housing, including a voice microphone generally located in the area of the first port, and a noise receiving microphone generally located in the area of the second port, wherein the voice microphone is held in place within a microphone mounting boot that allows sound to impinge the microphone in a configured pattern, and wherein the pattern is configured to optimize reception of desired vocal input and reduce the reception of non-desired noise input.

9. The telecommunications headset of claim 8, wherein the microphone boot is made of rubber, plastic, or another vibration- or sound-reducing material, and includes a hollow channel through which sound can impinge upon the microphone.

10. The telecommunications headset of claim 9, wherein the microphone boot and hollow channel is configured to allow sound to impinge the headset in a customized sound receiving pattern that suits the particular requirements of the telecommunications headset, and includes distinct pattern areas for vocal input and for noise input.

11. The telecommunications headset of claim 8, wherein the housing includes two metal or plastic grills placed over the microphone, including a first grill placed nearest each microphone, covered with the wind-resistant felt or other material, and then a second grill covering the wind-resistant felt.

12. A method for reducing noise in a telecommunications device, comprising:
providing one or more microphones, each of which is retained in a microphone boot that allows sound to impinge the microphone in a configured pattern, and wherein the pattern is configured to optimize reception of desired vocal input and reduce the reception of non-desired noise input;
providing a metal or plastic grill placed over the microphone to reduce the effect of wind hitting the microphone; and
providing a wind-resistant felt or other material placed between the microphone and the grill to reduce the velocity of wind hitting the microphones.

13. The method of claim 12, wherein the microphone boot is made of rubber, plastic, or another vibration- or sound-reducing material, and includes a hollow channel through which sound can impinge upon the microphone.

14. The method of claim 13, wherein the microphone boot and hollow channel is configured to allow sound to impinge the headset in a customized sound receiving pattern that suits the particular requirements of the telecommunications device, and includes distinct pattern areas for vocal input and for noise input.

15. The method of claim 12, wherein the housing includes two metal or plastic grills placed over the microphone, including a first grill placed nearest each microphone, covered with the wind-resistant felt or other material, and then a second grill covering the wind-resistant felt.

16. The method of claim 12, wherein the system is provided in a telecommunications, Bluetooth, or other headset.

17. The method of claim 12, wherein the system is provided in a speakerphone, or in-car speaker.
